(19) United States
(12) Patent Application Publication
(10) Pub. No.: US 2014/0202948 A1
(43) Pub. Date: Jul. 24, 2014

(54) Portable Liquid Purifying Apparatus

(71) Applicant: Xiaohang Li, Liuzhou (CN)

(72) Inventor: Xiaohang Li, Liuzhou (CN)

(21) Appl. No.: 14/163,068

(22) Filed: Jan. 24, 2014

Related U.S. Application Data
(60) Provisional application No. 61/756,445, filed on Jan. 24, 2013.

(51) Int. Cl. C02F 1/00; C02F 1/32

(52) U.S. Cl. CPC C02F 1/002; C02F 1/32; C02F 1/325
USPC 210/251

(57) ABSTRACT

Liquid purifying apparatus integrating a filter assembly and an ultraviolet light disinfection assembly that are suitable for portable water purification are described. A first apparatus includes a container, a cap assembly including a filter removably coupled to a first opening of the container and a disinfection assembly coupled to a second opening of the container and adapted to emit UV light to disinfect liquid in the container. A second apparatus includes upper and lower reservoirs, a filter assembly between the reservoirs, a disinfection assembly coupled to an opening in the lower reservoir and adapted to emit UV light to disinfect liquid in the lower reservoir and a spout in fluid communication with the lower reservoir.

### CROSS-REFERENCE TO RELATED APPLICATIONS

This application claims the benefit of Provisional U.S. Patent Application Ser. No. 61/756,445, filed on Jan. 24, 2013, pending, which is incorporated by reference herein in its entirety.

### BACKGROUND

1. Field of the Invention

The present invention relates to a portable liquid purifying apparatus integrating filtration and ultraviolet disinfection.

2. Description of the Related Art

Clean water is vital to human beings. Only about 2.5% of the Earth's water is fresh water. However, most fresh water found in rivers and lakes may not be safe enough to be consumed directly. The reason is that fresh water typically contains inorganic impurities such as sand, clay and suspended particles. Furthermore, freshwater may further contain organic contaminants, i.e., pathogens, such as bacteria, viruses and protozoan cysts.

For portable water purification, conventionally, chemical agents such as iodine tablets or containers with filter are used, but the drawback is obvious. The tablets change the water flavor and can impact a user's health due to side effects. Most filters cannot remove the pathogens that are smaller than the filter pores. Recently, ultraviolet (UV) light is increasingly used for portable water purification, for example, U.S. Pat. Nos. 6,110,424 and 5,900,212, and U.S. Patent Application Publication No. 2011/0174993 A1. However, these documents disclose the use of UV light for portable water purification wherein inorganic and organic impurities are not removed from the water after UV purification. Removal of these impurities would require a user to carry filters.

U.S. Pat. No. 7,641,790 includes both a filter and UV LED for purification. However, the UV LED disinfects water in a flow-through manner, which may have limited effectiveness since the output power of UV LED may be lower than required to disinfect flowing water. U.S. Pat. No. 7,713,483 proposes a cap filter which eliminates inorganic impurities before inserting a UV source into a water container. However, this device would require the user to carry separate parts of at least the cap filter and the UV source, and a user would have to inconveniently open the cap filter and insert the UV source in order to finish the purification process.

U.S. Pat. Nos. 7,438,799 and 7,632,397 integrate a UV lamp and filter in a water dispenser. However, these devices do not utilize UV LED technology in their embodiments. Also, the line-shaped UV lamps disclosed in these two patents are immersed into the water and are perpendicular to the bottom of the water container, which makes it difficult for users to clean the interior of the water container and increases the risk of breaking the lamps during cleaning. In addition, the cap and/or filter assembly can be contaminated when they are removed from the water container to allow new water to be added. There exists a need for a water purification apparatus that integrates both filtration and UV disinfection in which the UV light source does not extend into the interior of the container and which emits UV light towards an entirety of the container, including the cap and/or filter assembly. By emitting UV light towards an entirety of the container, including surfaces of the cap and filter assembly, the cap and filter assembly are exposed to UV light which sanitize their surfaces.

### SUMMARY

A portable liquid purifying apparatus is provided which comprises:

a liquid container having a top and a bottom, and having a first opening at the top, and having a second opening at the bottom, and having an internal compartment sized to hold a volume of liquid;

a cap assembly removably coupled to the first opening and adapted to restrict dispensing of the liquid from the internal compartment of the liquid container through the first opening;

a filter assembly comprising a filter housing coupled to the cap assembly and having an elongated body extending at least partway into the internal compartment of the liquid container and at least one filter media adapted to filter liquid passing through the cap assembly; and

a disinfection assembly coupled to the second opening at the bottom of the liquid container, wherein the disinfection assembly includes at least one ultraviolet (UV) emitter adapted to emit UV light in the germicidal spectrum onto fluid contact surfaces of the internal compartment to thereby disinfect a volume of the liquid held in the internal compartment of the liquid container.

A portable liquid purifying apparatus is provided which comprises:

a container having a top and a bottom, the container comprising:
an upper reservoir in fluid communication with a first opening at the top of the container;
a lower reservoir;
a second opening connecting the upper reservoir and the lower reservoir wherein the liquid in the upper reservoir can flow into the lower reservoir by action of gravity;
a third opening at the bottom of the container adjacent the lower reservoir;

a spout in fluid communication with the lower reservoir for dispensing liquid in the lower reservoir;

a lid removably coupled to the first opening and adapted to restrict dispensing of liquid from the upper reservoir through the first opening;

a filter assembly coupled to the second opening and adapted to restrict the flow of liquid from the lower reservoir through the upper reservoir, the filter assembly comprising:
a filter housing; and
at least one filter media adapted to filter liquid flowing through the filter assembly from the upper reservoir into the lower reservoir by action of gravity;

a disinfection assembly coupled to the third opening, wherein the disinfection assembly comprises at least one ultraviolet (UV) emitter capable of emitting UV light in the germicidal spectrum onto fluid contact surfaces of the lower reservoir to thereby disinfect a volume of the liquid in the lower reservoir.

### BRIEF DESCRIPTION OF THE DRAWINGS

The above and further advantages of the invention may be better understood by referring to the following description in conjunction with the accompanying drawings, in which:

FIG. 1A is an exploded cross-sectional side view illustrating a portable water purifying apparatus with a UV portion that does not extend into the internal compartment according to some embodiments of the present invention.

FIG. 1B is a cross-sectional top-down view illustrating a UV portion that does not extend into the internal compartment and which comprises a plurality of UV LEDs.

FIG. 1C is a cross-sectional top-down view illustrating a UV portion that does not extend into the internal compartment and which comprises a plurality of line-shaped UV lamps.

FIG. 1D is a cross-sectional top-down view illustrating a UV portion that does not extend into the internal compartment and which comprises a plurality of circular or semi-circular UV lamps.

FIG. 1E is an exploded cross-sectional side view illustrating a portable water purifying apparatus with a UV portion comprising a plurality of UV lamps that extends into the internal compartment according to some embodiments of the present invention.

FIG. 1F is an exploded cross-sectional side view illustrating a portable water purifying apparatus with a UV portion comprising a plurality of UV LEDs that extends into the internal compartment according to some embodiments of the present invention.

FIG. 1G is a cross-sectional bottom-up view illustrating a disinfection assembly comprising an energy-conversion power source such as a solar panel, a thermoelectric or a triboelectric generator.

FIG. 2A is a cross-sectional side view illustrating a portable water purifying apparatus with a UV portion that does not extend into the internal compartment according to some embodiments of the present invention.

FIG. 2B is a cross-sectional top-down view illustrating a UV portion that does not extend into the internal compartment and which comprises a plurality of UV LEDs.

FIG. 2C is a cross-sectional top-down view illustrating a UV portion that does not extend into the internal compartment comprises a plurality of line-shaped UV lamps.

FIG. 2D is a cross-sectional top-down view illustrating a UV portion that does not extend into the internal compartment and which comprises a plurality of circular or semi-circular UV lamps.

FIG. 2E is a cross-sectional side view illustrating a portable water purifying apparatus with a UV portion comprising a plurality of UV LEDs that extends into the internal compartment according to some embodiments of the present invention.

FIG. 2F is a cross-sectional bottom-up view illustrating a disinfection assembly comprising an energy-conversion power source such as a solar panel, a thermoelectric or a triboelectric generator.

### DETAILED DESCRIPTION

The present invention will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will be thorough and complete, and will fully convey the scope of the invention to those skilled in the art. In the drawings, the size and relative dimensions of layers and regions may be exaggerated for clarity. Like numbers refer to like elements throughout.

It will be understood that when an element such as a layer, region or substrate is referred to as being “on” another element, it can be directly on the other element or intervening elements may also be present. It will be understood that these terms are intended to encompass different orientations of the system in addition to the orientation depicted in the figures. The term “directly” means that there are no intervening elements. As used herein, the term “and/or” includes any and all combinations of one or more of the associated listed items.

It is to be understood that, although the terms “first”, “second”, etc. may be used herein to describe various elements, components, regions, layers and/or sections, these elements, components, regions, layers and/or sections, should not be limited by these terms. These terms are only used to distinguish one element, component, region, layer or section from another element, component, region, layer or section. Thus, a “first” element, component, region, layer or section discussed below could be termed a “second” element, component, region, layer or section without departing from the teachings of the present invention.

Embodiments of the invention are described herein with reference to cross-sectional, perspective, and/or plan-view illustrations that are schematic illustrations of idealized embodiments of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a region illustrated or described as a rectangle may have rounded or curved features due to normal manufacturing tolerances. A region illustrated as circular may have other shapes, such as rectangular, oval and so on. Thus, the layers and regions illustrated in the figures are schematic in nature and their shapes are not intended to illustrate the precise shape of a region of a system and are not intended to limit the scope of the invention.

It will be understood that all terms including technical and scientific terms used herein have the same meaning as commonly understood by those skilled in the art to which this invention belongs, unless otherwise defined. It will be also understood that terms, such as those defined in commonly used dictionaries, should be interpreted as having a meaning that is consistent with their meaning in the context of the relevant art and this specification will not be interpreted in an idealized or overly formal sense unless expressly so defined herein.

As understood by those skilled in the art, fluids are a subset of the phases of matter and include liquids, gases, plasmas and, to some extent, plastic solids. As such, the word “fluids” will be referred to as liquid and/or gas in the following context, for example, drinking water and breathing air.

As used herein, the term “ultraviolet lamp” and/or “UV lamp” in the present invention refer to a common mercury-based lamp emitting light in the germicidal spectrum with single or multiple wavelengths. As used herein, the term “ultraviolet light-emitting device” and/or “UV LED” in the present invention refer to a light-emitting diode, laser diode or other semiconductor devices emitting light from 210 nm to 400 nm with single or multiple wavelengths. As used herein, “ultraviolet emitter” and/or “UV emitter” refers to UV-light sources such as UV lamp or UV LED. The term “visible light emitters” refers to semiconductor-based visible light emitters such as a light emitting diode and laser diode emitting light from 400 nm to 650 nm with single or multiple wavelengths. The UV LED and visible light emitter comprise at least one solid state semiconductor layer, for example, silicon, silicon carbide, III-nitride compounds, and/or other semiconductor materials. The design, growth and fabrication of conventional ultraviolet light-emitting devices are understood to those skilled in the art and need not to be described in detail herein. UV LEDs are commercially available from manufacturers like Sensor Electronic Technology, Inc. (Columbia, S.C.) and visible light emitters such as blue LED and blue laser diode are commercially available from many manufacturers.

The UV LED and visible light emitters may suffer from a loss of efficiency during life of usage. There have been many prior arts describing methods of compensating the loss of efficiency and optical output power of visible LEDs especially in display applications, for example, U.S. Pat. No. 7,847,764, U.S. Pat. No. 6,414,661, U.S. Pat. No. 6,456,016 and U.S. Pat. No. 6,504,565. However, there are no methods that are adapted to estimate the remainder of the lifetime and efficiency of the UV LED and visible light emitter in water purification equipment and compensate the decreased optical output power over accumulative usage. The purpose of compensating the UV LED and visible light emitter is to maintain a sufficient germicidal exposure dose for a certain amount of fluid, which is different from compensating visible light emitter for lighting uniformity across an array of visible LEDs. For example, the current standard for Class A systems for UV water treatment, namely NSK/ANSI Standard 55, mandates that such systems provide at least 40 mJ/cm². Without compensation of output power of the UV LED, the users will suffer a gradual loss of purification effect that compromises the purification quality. The compensation method is described in U.S. Provisional Patent Application Ser. No. 61/701,712, which is incorporated herein by reference in its entirety.

As used herein the term “output power” means the power of germicidal light to which the fluid of interest is exposed. As understood by those skilled in the art, the power of germicidal light is calculated by integrating photon energies within unit time and germicidal wavelength range. Therefore, “output power” is a generic term which may also stand for other radiometric quantities that are interrelated, such as irradiance, radiance, radiant intensity, spectral intensity in various embodiments.

As used herein, the phrase “fluid contact surface” refers to surfaces of the various components of the apparatus which can come into contact with liquid in the interior of the container, particularly after the container has been sealed.

The present invention relates to a portable liquid purifying apparatus integrating a filter assembly and a UV disinfection assembly, thereby thoroughly purifying liquid in the container dispensed by a user.

A first disclosed feature is a portable liquid purifying apparatus integrating a filter assembly and a UV disinfection assembly at the top and bottom of the container, respectively. The water held in the container first receives UV disinfection by the UV assembly and then is dispensed through the filter assembly.

A second disclosed feature is a portable liquid purifying apparatus integrating a filter assembly in the fluid passage of a container and a UV disinfection assembly at the bottom of the fluid container, respectively. The water first flows through the filter and then receives UV disinfection by the UV portion before being dispensed.

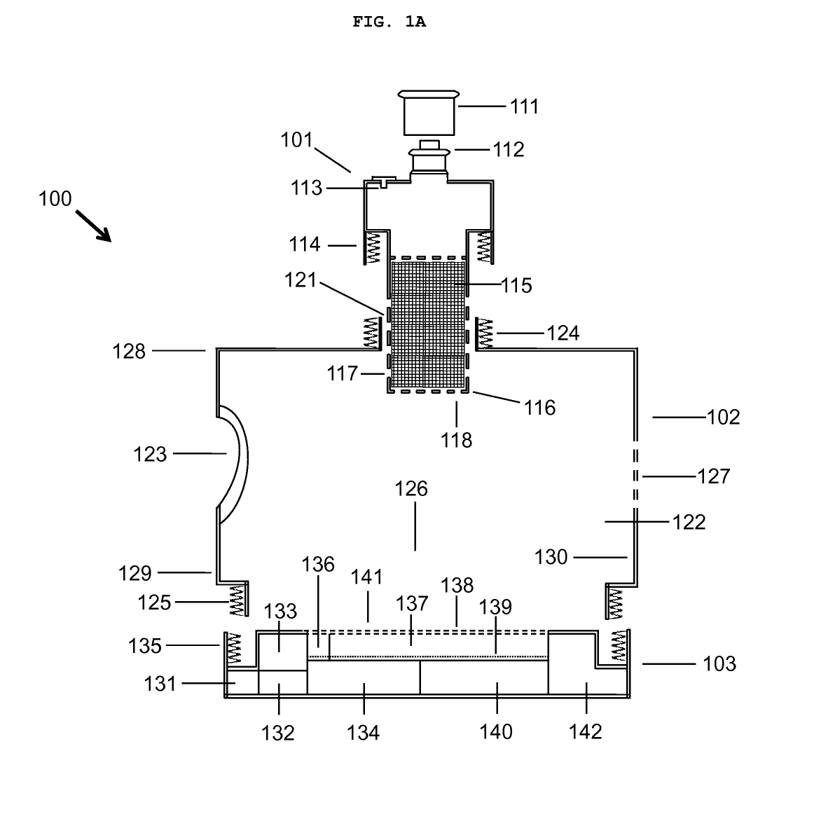

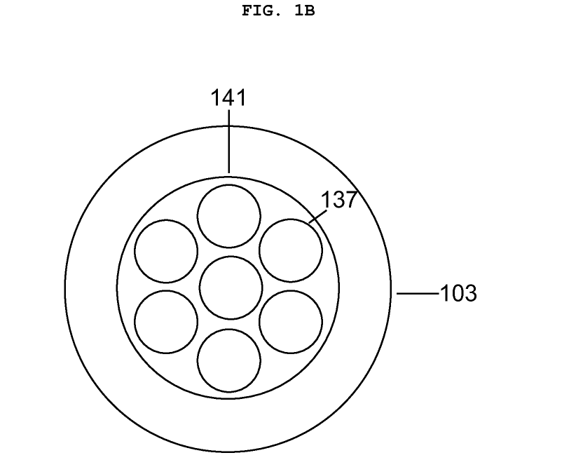

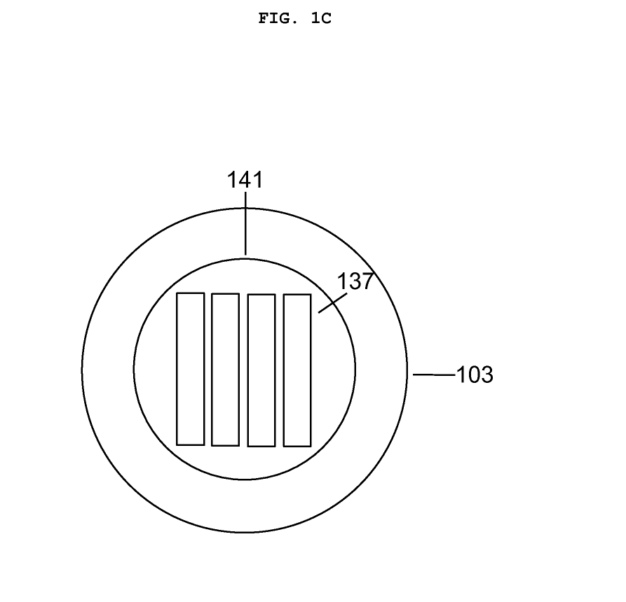

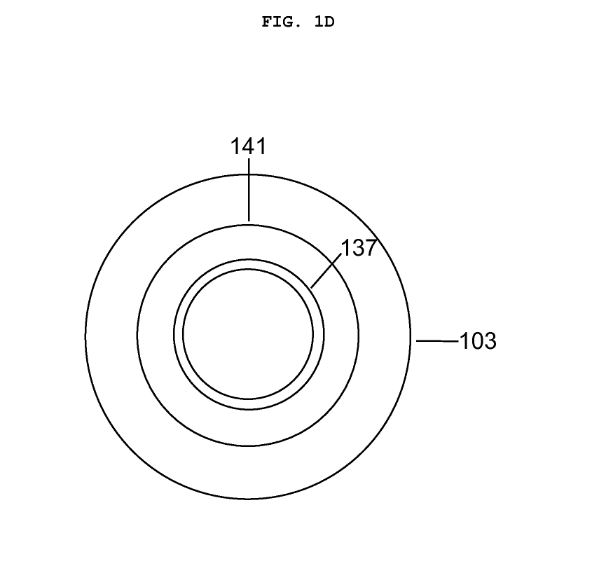

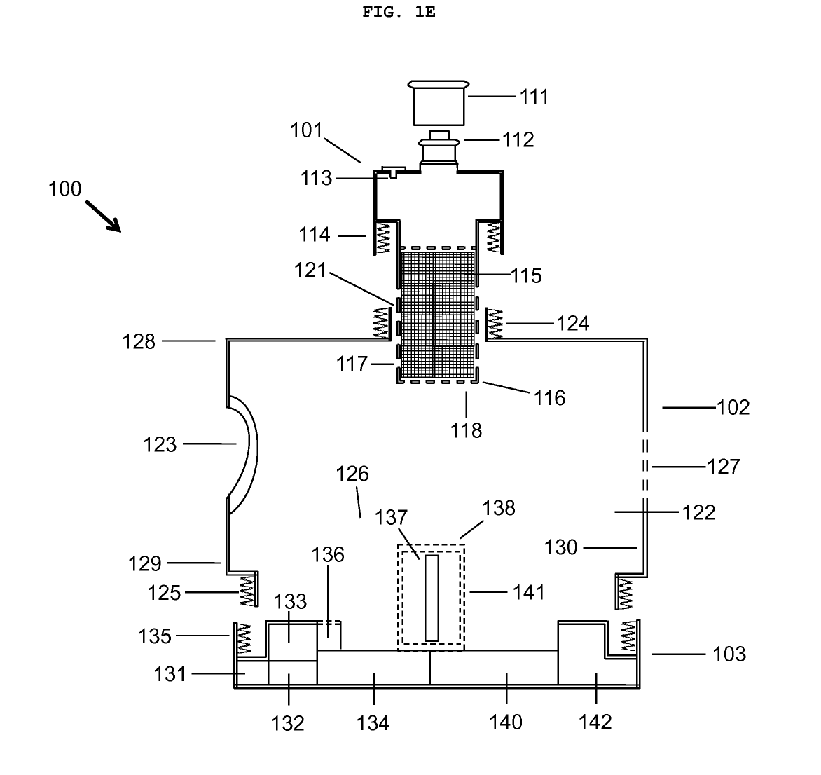

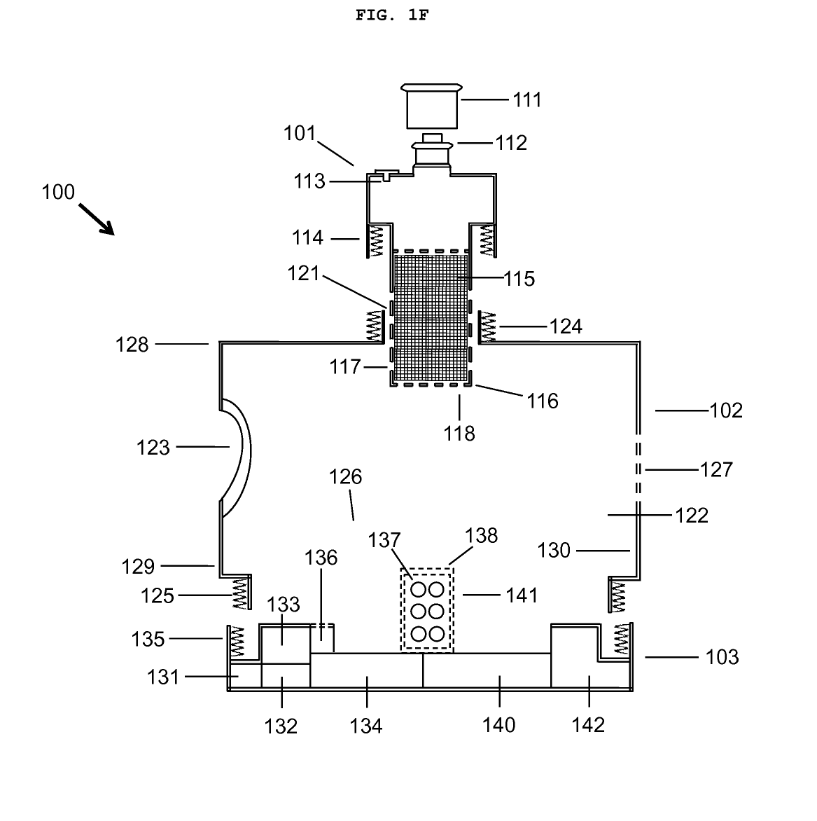

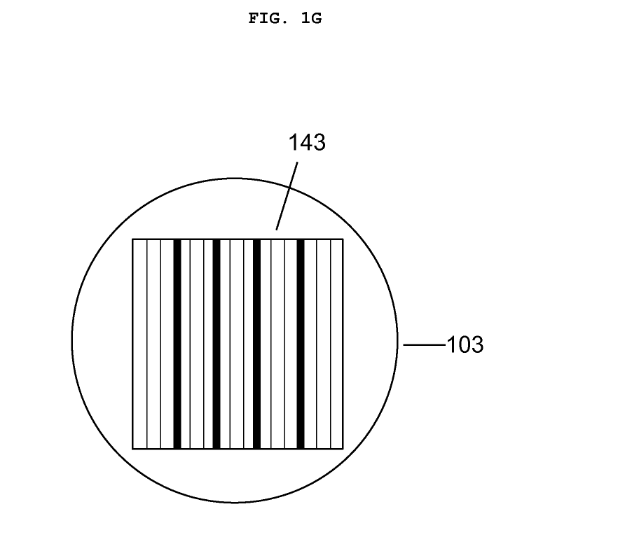

Referring now to the present invention in more detail, FIGS. 1A-1F illustrate a portable liquid purifying apparatus 100 according to some embodiments of the present invention.

The liquid purifying apparatus 100 comprises three main parts, a cap assembly 101, a liquid container 102, and a disinfection assembly 103.

The cap assembly 101 has an elongated body 118 which includes a filter housing 116 that is filled with filter media 115. Other than the filter media 115, the cap assembly 101 can be constructed out of polyethylene, polypropropylene, polyvinyl chloride, polyethylene terepthalate, or any other suitable natural or synthetic materials. In some embodiments, a user may replace the cap assembly 101 as a whole after the filter media 115 reaches the usage lifetime if the filter housing 116 is secured permanently to the cap assembly 101. In some other embodiments, a user just needs to replace the filter housing 116 if the housing 116 is removably attached to the cap assembly 101. The filter housing 116 can have a cylindrical or frustoconical shape, but any other suitable size and dimension is within the scope of the present invention. Although not shown in FIG. 1A, it is contemplated that the filter housing 116 can have a flange or other suitable coupling means, including but not limited to, threaded and magnetic couplings, which allow the filter housing 116 to couple to an interior surface of the cap assembly 101. The filter medium 115 may include but not limit to, high reactivity carbon mixture, activated carbon, iodinated resin, hollow fiber membrane, combinations thereof, or any other suitable compositions of different filtering materials. It is understood that the filter medium 115 can be in granular form and contained within a mesh bag or other replaceable cartridge. The filter housing 116 can have a large number of vent-holes 117 that allow liquid to freely flow through the filter medium 115. The number, size, shape and placement of the vent-holes 117 can vary depending on the preferred design of the filter housing 116. In some embodiments, the cap assembly 101 can have a check valve 113 that allows air to flow back into the liquid container 102 after the container 102 is pressurized. Although not shown, the check valve 113 may alternatively be installed on the filter housing 116. The cap assembly 101 further includes an adapter 112 and nozzle outlet 111 that are in fluid communication with the filter medium 115, vent-holes 117 and internal compartment 122 of the liquid container 102. When the container 102 is pressurized, the liquid held in the internal compartment 122 will flow through the filter media 115 and out through the adapter 112 and nozzle outlet 111. In some embodiments, the container 102 is pressurized by user's sipping through the nozzle outlet 111. The cap assembly 101 is removably and fluid-tightly coupled to the liquid container 102. In some embodiments as shown in FIG. 1A, they are coupled by virtue of their complementary threads 114 and 124. Alternatively, other common coupling methods may be used instead of thread coupling.

The liquid container 102 has a top 128 with a first opening 121 and a bottom 129 with a second opening 126. The liquid container 102 may comprise a plurality of layers which can be constructed out of any suitable material. In some embodiments, the container 102, disinfection assembly 103 and/or cap assembly 101 may comprise a plurality of layers of heat-insulating materials, heat-storage materials and/or vacuum, which help keep temperature of the liquid stable in the container 102. When the cap assembly 101 is fluid-tightly coupled to the container 102, the elongated part 118 may or may not extend partway through the first opening 121 into the internal compartment 122 of the container 102, depending on vertical length of the housing 116. In some embodiments when the liquid container 102 is made of hard materials and does not have a check valve and thus becomes difficult to squeeze, the container 102 may include a squeezable portion 123, which may be made of flexible materials like rubber and can be squeezed by a user to pressurize the internal compartment 122. In some embodiments, the entire container 102 may be made of flexible material(s) and can be squeezed by a user to pressurize the compartment 122. Although not shown in FIG. 1A, a second check valve may be installed on the liquid container 102 or the squeezable portion 123, which can allow air to flow back into the container 102 after the container 102 is pressurized. The interior surface 130 of the liquid container 102 may be germicidal-light reflective so as to facilitate the reflection of UV light within the container 102.

As shown in FIG. 1A, the disinfection assembly 103 is removably coupled to the second opening 126 through engagement of complementary threads 135 and 125. Thus the liquid container 102 may be cleaned independently after the cap assembly 101 and the disinfection assembly 103 are uncoupled. It is within the scope of present invention that the threads 114 and 135 are of the same type. Alternatively, other common coupling methods may be used instead of thread coupling. Alternatively, the disinfection assembly may be permanently coupled to the second opening.

As shown in FIG. 1A, the disinfection assembly 103 includes a power port 131, a power supply 132, a controller 133, a user control interface 134, a plurality of UV emitters 137, an indicator 136, a UV transmissive lens 138 and a UV reflective surface 139. In some embodiments, the disinfection assembly 103 may additionally include a user display 140 and a sensor 142. FIG. 1A and FIGS. 1E-1F schematically illustrates the UV emitter 137, the controller 133, the user control 134, the indicator 136, UV emitter 137, the user display 140 and the sensor 142 as being operatively connected to each other. These figures, however, should not be interpreted as illustrating a wiring diagram associated with the disinfection assembly 103. Rather, the schematic illustration of disinfection assembly 103 graphically represents that various components of the disinfection assembly 103 may be connected to each other, interact with each other, and/or otherwise collectively form the disinfection assembly 103, or at least a portion thereof. For example, as an illustrative, non-limiting example, the power supply 132 may be adapted to power the UV emitter 137, the controller 133, the user control 134, the user display 140, and the sensor 142; however, it is within the scope of the present disclosure that the power supply 132 may be directly connected to the controller 133, which in turns controls and distributes the power to the various other components, for example. The power supply 132 may receive and convert power from power grid through the power port 131 to power the above-mentioned electrical components. Or the power from power grid is used to charge batteries (not shown) within the power supply 132, and then the batteries are used to power the electrical components of the assembly 103. The power port 132 may comprise one of the common power ports including but not limited to Universal Serial Bus (USB) and micro-USB. In some embodiments, the disinfection assembly 103 may receive power wirelessly, and thus, the power port 131 comprises interfaces compatible with wireless charging or powering. In some embodiments, the power supply 132 may receive power from an energy-conversion power source 143. For example, the solar panel 143 may be installed on the bottom of the disinfection assembly 103, as shown in FIG. 1G. In some embodiments, a user may charge the battery or provide power by using an external power source such as a solar panel through the power port 131.

According to some embodiments, the liquid purifying apparatus 100 may be connected to an external device and can be monitored and/or controlled by the external device wirelessly or through a cable. Exemplary non-limiting devices of the external device include a computer, a smartphone, a tablet, a smart watch, wearable devices like smart glasses or other portable and non-portable computer devices.

The UV emitter 137, a major part of a UV portion 141 can take any suitable form and is configured to emit UV light in the conventional germicidal spectrum, 210 nm-300 nm. Recently, there are scientific studies [Maclean, Applied and Environmental Microbiology, 2009] showing that non-UV-C light can also be used for disinfection. Thus the emitter 173 may alternatively or additionally comprise a plurality of visible light emitters in some embodiments. The UV portion 141 may be positioned within the cap assembly 103 (i.e. the UV portion 141 does not extend upwards into the internal compartment) such that, when activated, the UV emitter 137 emits light upwards and toward an entirety of the internal compartment 122 so as to disinfect the stored liquid, filter housing 116 and/or interior surface 130 of the container 102. As shown in FIGS. 1B-1D, the UV emitter 137 may include but is not limited to, a plurality of UV LEDs (FIG. 1B), a plurality of line-shaped or U-shaped UV lamps (FIG. 1C), a plurality of circular or semi-circular UV lamps (FIG. 1D). Additionally or alternatively, the UV portion 141 may be positioned, and the cap assembly 101, the liquid container 102 and the disinfection assembly 103 may be shaped, or otherwise configured, so that an entire volume of liquid within the liquid container 103 can be disinfected with minimal user effort. In some embodiments, a user may agitate or flip the container 100 gently to achieve required disinfection level.

In some embodiments, the UV portion 141 may extend upright partially or even completely into the internal compartment 122. Other configurations are also within the scope of the present disclosure, including, as mentioned, configurations in which the UV portion 141 is positioned on or within the liquid container 102. As shown in FIG. 1E (UV emitter 137 comprises a plurality of UV lamps) and FIG. 1F (UV emitter 137 comprises a plurality of UV LEDs), the UV portion 141 extends into the internal compartment. In some embodiments, the disinfection assembly 103 may be configured so that the UV emitter 137 can be non-invasively removed from the disinfection assembly so that a replacement can be installed.

The UV emitter 137 is configured to disinfect the liquid for a predetermined period of time out of its working lifespan, which may also be described as a predetermined number of disinfection cycles, after which efficiency and/or optical output power of the UV emitter 137 may begin to decline and eventually cease to be effective. Typically UV LED and UV lamp have characteristics that limit a number of disinfection cycles over their lifetime.

Accordingly, the controller 133 may be configured to record the number of disinfection cycles and/or the total length of time the UV emitter 137 has been turned on. The controller 133 may further have the ability to control or restrict a user's ability to turn on the UV emitter 137 after a predetermined number of disinfection cycles or length of time the UV emitter 137 has been turned on, such as based on an optical output power or efficiency of the UV emitter 137, which may be obtained from the manufacturers of the UV emitter 137.

The controller 133 may additionally be configured to restrict the use of the UV emitter 137 and/or the disinfection assembly 103 if the power supply 132 provides insufficient power or charge to complete a disinfection cycle or support normal operation of other electrical parts such as the user display 140. Other configurations are also within the scope of the present disclosure.

The controller 133 may additionally configure the user display 140 to display information such as number of disinfection cycles having occurred, time, temperature, humidity, water condition, GPS location, UV emitter′ remaining working lifetime, remaining battery percentage, remaining time until a full charge of the power supply, weather, alerts of changing battery, warning, alert of replacing filter, and disinfection status. Display technologies such as liquid crystal display, e-ink display and organic light emitting diode display may be used. In some embodiments where the apparatus 100 is monitored and/or controlled by an external device, some or all the information may be displayed on the external device. Other configurations are also within the scope of the present invention.

The UV emitter 137 may comprise UV LED or UV lamp. UV LEDs are commercially available from companies such as Sensor Electronic Technology, Inc. (Columbia, S.C.). UV lamps emitting in germicidal spectrum are commercially available from companies such as Philips Electronics North America Corporation (Andover, Mass.).

The user control 134 is configured in any suitable form, which permits a user to turn on/off the UV emitter 137 for a predetermined period of time to disinfect liquid in the container 102. In some embodiments, a user may be able to select the volume of liquid in the container 102 by observing the liquid level through a transparent or translucent portion 127 on the container 102. Then the controller 133 may determine the period of disinfection time accordingly, for example, 90 seconds if the water level reaches half of the container 102 or 180 seconds if the water level reaches maximum water level in the container 102. It is within the scope of the present invention that the periods of time greater, less than or within the exemplary ranges may be used.

In some embodiments, the disinfection assembly may further include a sensor 142, which may be used to detect liquid pressure (i.e. water volume), existence of liquid in the container 102 and/or temperature. As a water pressure detector, the sensor 142 may work with the controller 133 to automatically determine the time period of disinfection based on the water pressure and hence water volume the sensor 142 detects. In some embodiments, if being used to detect the existence of liquid, the sensor 142 may work with the controller 133 to turn on the UV emitter 137 when liquid enters the internal compartment 122 and cover the disinfection assembly, which acts as a safety interlock to prevent accidental UV light exposure when the disinfection assembly 103 is not coupled to the liquid container 102. In some embodiments, the sensor 142 may work with the controller 133 to keep the UV emitter 137 on for a short period of time such as a few seconds or for an entire UV disinfection cycle when liquid is not in contact with the sensor 142, such that when a user agitates or flips the apparatus 100 during the UV disinfection cycle, the UV emitter won't be off when liquid happens to be not in contact with the sensor 142. In some embodiments, the user control 134 may allow a user to indirectly select the mode of UV light emission, including pulse mode and continuous-wave mode. A recent study published by Wengraitis et al. (Photochemistry and Photobiology, 2013) suggests that energy efficiency of disinfection by UV-C light could be enhanced by introducing pulse mode with certain duty cycles and frequencies, in comparison with conventional continuous-wave mode. Therefore the user control 134 may be configured such that a user may select “fast” (continuous-wave mode) or “energy-saving” (pulse mode) modes. The user control 134 and user display 140 may be integrated into the same screen with development in the touch screen technology.

In some embodiments, the disinfection assembly 103 may further include an indicator 136, which can be configured to indicate to a user when the UV emitter 137 is turned on, battery status and so on. The indicator 136 can comprise a plurality of devices, such as but not limited to, a visible light emitter, a vibrator or a buzzer. In some embodiments in which the UV emitter 137 comprises a UV lamp that may emit light in visible spectrum in addition to light in germicidal spectrum. The visible light from the UV lamps can thus indicate to a user that the UV emitter 137 is turned on. In some embodiments, the indicator 136 may comprise a plurality of visible LEDs, which become illuminated before, when, and/or after the UV light is emitted. In such embodiments, the indicator 136 may be protected by the UV transmissive lens 138 or another lens from contacting the liquid in the container 102. A reflective surface may be positioned below the indicator 136 to increase brightness. In some embodiments, the indicator 136 may be turned on by a user to provide lighting in dark environment. The indicator 136 may be integrated into the user display 140 in some embodiments.

A UV portion 141 of the present invention comprises said UV emitter 137, a UV transmissive lens 138, and optionally a UV reflective surface 139. The UV transmissive lens 138 may be constructed of materials with high transmittance to germicidal wavelengths, including but not limited to, quartz, sapphire and polytetrafluoroethylene. In some embodiments, the UV transmissive lens may be mesh, or otherwise include perforations, through which UV light in the germicidal spectrum may pass. Additionally, the UV transmissive lens 138 is configured to prevent the liquid from contacting the UV emitter 137 and other electrical components. Thus, the UV transmissive lens 138 may be coupled within the disinfection assembly 103 by a water-tight seal. Additionally, the UV transmissive lens 138 may be configured to regulate the path of UV light from the emitter 137 in a preferred way that the UV light passing the lens 138 reaches the entirety of the internal compartment 122, including focusing, diffusing, spreading. The lens 138 may be sized, positioned or shaped to achieve said functions. In some embodiments, the space where the UV emitter 137 is positioned may contain a partial vacuum. In such embodiments, the UV transmissive lens 138 insulates the UV emitter 137 from air and thus protects the vacuum. The UV reflective surface 139 is represented by a dotted line in FIG. 1A. In some embodiments, the UV reflective surface 139 may be configured to at least partially reflect the UV light from the emitter 137 towards the internal compartment 122. In such embodiments, the UV reflective surface 139 may be positioned below the UV emitter 137 (i. e. opposite to the UV light emission direction of interest), as shown in FIG. 1A. Additionally, the UV reflective surface 139 may be positioned, sized and shaped to focus, diffuse or spread the reflected UV light in an optimum configuration to maximize UV disinfection efficiency. Additionally or alternatively, the UV reflective surface 139 may be parabolic or at least partially spherical. The UV reflective surface 139 may comprise layer(s) of reflective material(s), such as but not limited to, aluminum alloy, stainless steel, biaxially-oriented polyethylene terephthalate, etc. The UV reflective surface may have a greater UV reflectivity than the material from which the body of disinfection assembly is made, and thereby reflect more and absorb less of UV light in the germicidal spectrum than if the UV reflective surface 139 were not included.

As shown in FIG. 1A, mouthpieces such as the adapter 112 and nozzle outlet 111 may be included to selectively dispense liquid from the apparatus 100 without removal of the cap assembly 101. In some embodiments, a straw (not shown) may be used and operatively coupled to the filter housing 116 and extend into the container 102.

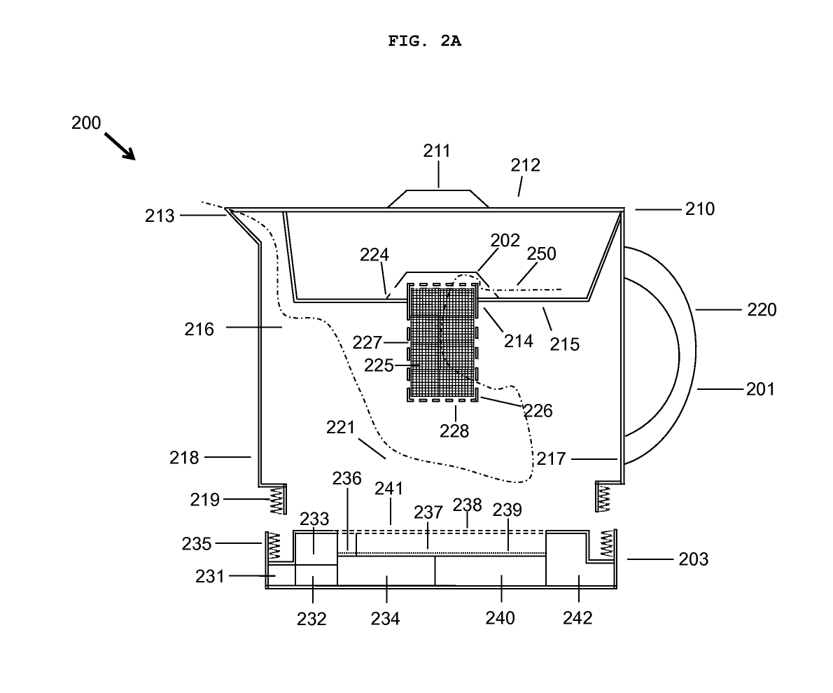

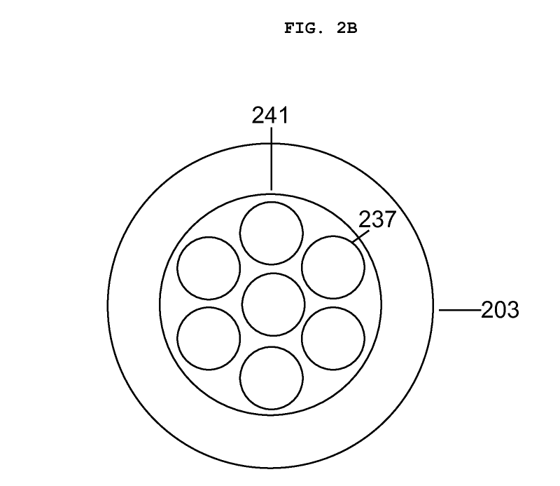

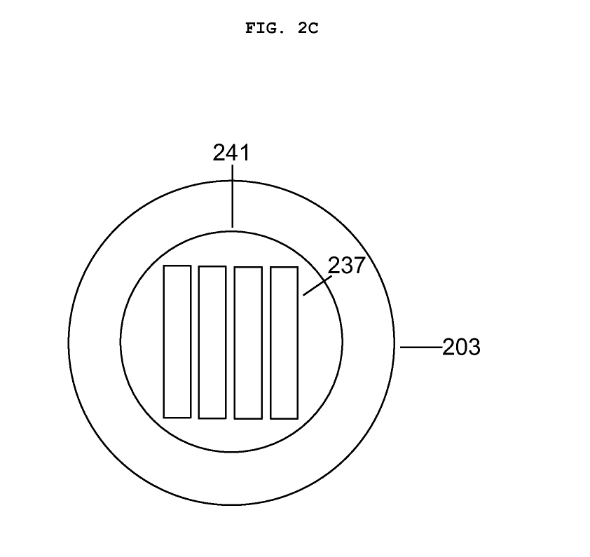

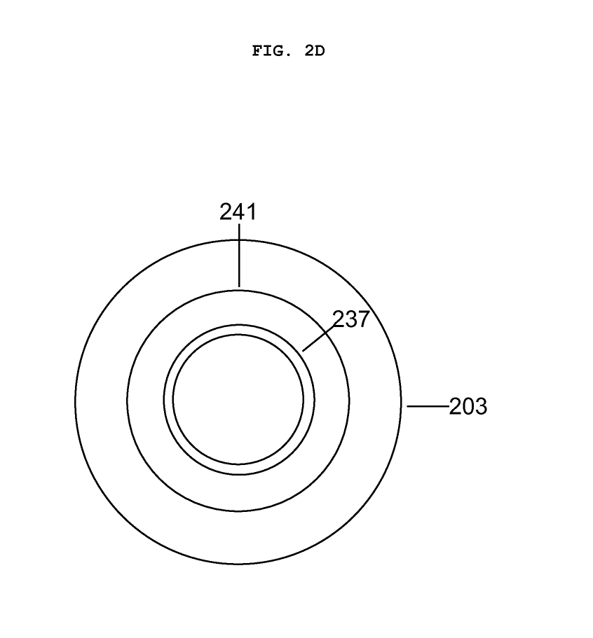

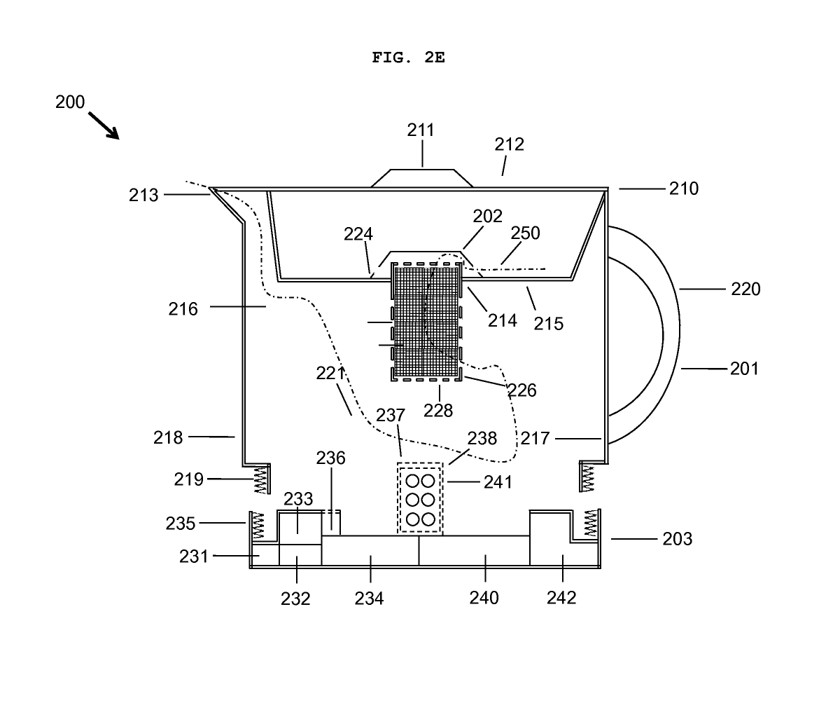

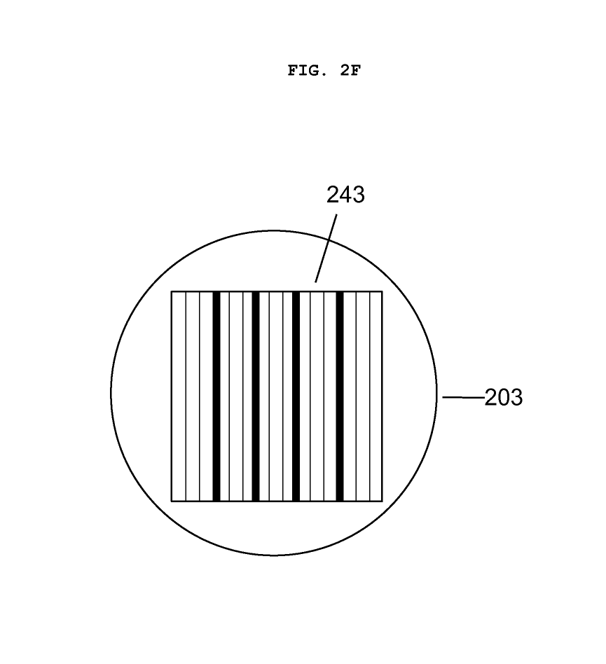

Referring now to the present invention in more detail, FIGS. 2A-2F illustrate a portable liquid purifying apparatus 200 based on some embodiments of the present invention.

The apparatus 200 comprises three main parts, a container 201, a filter assembly 202, and a disinfection assembly 203.

The container 201 has a top 210 with a first opening 212 and a bottom 218. The container 201 can be constructed out of any suitable material. According to some embodiments, the container 201 and/or disinfection assembly 203 may comprise a plurality of layers of heat-insulating materials, heat-storage materials or vacuum, which help keep temperature of the liquid stable in the container 201. As shown in FIG. 2A, the container 201 further comprises an upper reservoir 215 mounted at the top 210 with a second opening 214 and a lower reservoir 216. A third opening 221 is at the bottom 218. The capacity of the lower reservoir 216 is at least as great as or larger than that of the upper reservoir 215. The first opening is coverable by a first lid 211 by common ways of coupling. The interior surface 217 of the container 201 may be germicidal-light reflective so as to facilitate the reflection of UV light within the lower reservoir 216. In some embodiments, the container 201 may include a handle 220 for a user to dispense liquid in the lower reservoir 216 through a spout 213. In some embodiments, a second lid (not shown) may be used to cover the spout 213.

As shown in FIG. 2A, the filter assembly 202, coupled to the second opening 214 of the upper reservoir 215 by a coupling structure 224, has a body 228 which includes a filter housing 226 that is filled with filter media 225. The number, size, shape and placement of the coupling structure 224 can vary depending on the preferred design of the filter assembly 202. When the filter assembly 202 is coupled to the upper reservoir 215, the body 228 may extend partway into the upper reservoir 215 and/or lower reservoir 216 of the container 201. The filter assembly 202 can be constructed out of polyethylene, polypropropylene, polyvinyl chloride, polyethylene terepthalate, or any other suitable natural or synthetic material. In some embodiments, a user may need to replace the filter assembly 202 as a whole after the filter media 225 reaches the usage lifetime if the filter housing 226 is secured permanently to the filter assembly 202. In some other embodiments, a user may just need to replace the filter housing 226 if the housing 226 is removably attached to the filter assembly 202. The filter housing 226 can have a cylindrical or frustoconical shape, but any other suitable size and dimension is within the scope of the present invention. Although not shown in FIG. 2A, it is contemplated that the filter housing 226 can have a flange or other suitable coupling means, including but not limited to, threaded and magnetic couplings, which allow the filter housing 226 to couple to an interior surface of the filter assembly 202. The filter medium 225 may include but not limit to, high reactivity carbon mixture, activated carbon, iodinated resin, hollow fiber membrane, combinations thereof, or any other suitable compositions of different filtering materials. It is understood that the filter medium 225 can be in granular form and contained within a mesh bag or other replaceable cartridge. The filter housing 226 can have a plurality of vent-holes 227 that allow liquid to freely flow through the filter medium 225. The number, size, shape and placement of the vent-holes 227 can vary depending on the preferred design of the filter housing 226.

The disinfection assembly 203 can be permanently coupled to the third opening 221 in some embodiments. As shown in FIG. 2A, the disinfection assembly 203 is removably coupled to the third opening 221 through engagement of complementary threads 219 and 235. Thus the container 201 may be cleanly independently after the filter assembly 202 and the disinfection assembly 203 are uncoupled from the container 201. As shown in FIG. 2A, the disinfection assembly comprises a controller 233, a power supply 232, a user control 234, a UV portion 241 which includes a UV transmissive lens 238, a UV reflective surface 239 and a plurality of UV emitters 237, and a user display 240. The disinfection assembly 203 may additionally comprise a power port 231 and/or a sensor 242 in various embodiments.

Although FIGS. 2A-2D shows some embodiments wherein the UV portion 241 does not extend into the lower reservoir 216, the UV portion 241 comprising a plurality of UV LEDs may extend into the lower reservoir 216 in some other embodiments, as shown in FIG. 2E.

A passage of liquid 250 through the container is shown in FIGS. 2A and 2E. A water purification cycle may include the following steps: 1. the first lid 214 is opened by a user; 2. the upper reservoir 215 is fed with unpurified water; 3. the water flows by action of gravity from the upper reservoir 215 through the filter medium 225 into the lower reservoir 216. In some embodiments, manual pressure can be added to speed up this process; 4. The filtered water in the lower reservoir 216 receives UV light disinfection for a predetermined period of time; 5. The disinfected water is dispensed or consumed through the spout 213 by a user. In some embodiments, a straw (not shown) may be used and operatively coupled to the spout 213 and extend into the lower reservoir 216. Thus a user may consume the water by sipping through the straw.

The disinfection assembly 203 used for the embodiments shown in FIGS. 2A-2E has the same or similar characteristics as the disinfection assembly 103 described above for the embodiments of FIGS. 1A-1E.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A liquid purifying apparatus, comprising:
a liquid container having a top and a bottom, and having a first opening at the top, and having a second opening at the bottom, and having an internal compartment sized to hold a volume of liquid;
a cap assembly removably coupled to the first opening and adapted to restrict dispensing of the liquid from the internal compartment of the liquid container through the first opening;
a filter assembly comprising a filter housing coupled to the cap assembly and having an elongated body extending at least partway into the internal compartment of the liquid container and at least one filter media adapted to filter liquid passing through the cap assembly; and
a disinfection assembly coupled to the second opening at the bottom of the liquid container, wherein the disinfection assembly includes at least one ultraviolet (UV) emitter adapted to emit light in the germicidal spectrum onto fluid contact surfaces of the internal compartment to thereby disinfect a volume of the liquid held in the internal compartment of the liquid container.

2. The liquid purifying apparatus of claim 1, wherein:
the cap assembly defines a liquid passage through which the liquid can be selectively dispensed from the liquid container through the filter housing; and
wherein the cap assembly further includes a mouthpiece in fluid communication with the liquid passage, wherein the mouth piece is configured to selectively dispense the liquid without removal of the cap assembly from the liquid container.

3. The liquid purifying apparatus of claim 1, wherein the UV emitter is a UV mercury lamp.

4. The liquid purifying apparatus of claim 1, wherein the UV emitter is a UV light-emitting diode.

5. The liquid purifying apparatus of claim 1, wherein the elongated body has a plurality of apertures.

6. The liquid purifying apparatus of claim 1, wherein the UV emitter does not extend into the internal compartment.

7. The liquid purifying apparatus of claim 1, wherein the UV emitter comprises one or more UV LEDs, line-shaped UV lamps, U-shaped UV lamps, circular UV lamps or semi-circular UV lamps.

8. The liquid purifying apparatus of claim 1, wherein the UV emitter is adapted to emit light in the germicidal spectrum onto fluid contact surfaces of the cap assembly and/or the filter assembly.

9. The liquid purifying apparatus of claim 1, wherein:
at least a portion of the liquid container is flexible and can be squeezed by a user to pressurize the internal compartment; and/or
the cap assembly and/or the liquid container comprises a check valve that allows air to flow back into the liquid container when pressure in the container is lower than air pressure outside of the container.

10. The liquid purifying apparatus of claim 1, wherein the filter housing is coupled to the cap assembly by a threaded or magnetic coupling.

11. The liquid purifying apparatus of claim 1, wherein the disinfection assembly is coupled to the second opening at the bottom of the liquid container by a threaded coupling.

12. A liquid purifying apparatus, comprising:
a container having a top and a bottom, the container comprising:
an upper reservoir in fluid communication with a first opening at the top of the container;
a lower reservoir;
a second opening connecting the upper reservoir and the lower reservoir wherein the liquid in the upper reservoir can flow into the lower reservoir by action of gravity;
a third opening at the bottom of the container adjacent to the lower reservoir;
a spout in fluid communication with the lower reservoir for dispensing liquid in the lower reservoir;
a lid coupled to the first opening and adapted to restrict dispensing of liquid from the upper reservoir through the first opening;
a filter assembly coupled to the second opening and adapted to restrict the flow of liquid from the lower reservoir through the upper reservoir, the filter assembly comprising:
a filter housing; and
at least one filter media adapted to filter liquid flowing through the filter assembly from the upper reservoir into the lower reservoir by action of gravity;
a disinfection assembly coupled to the third opening, wherein the disinfection assembly comprises at least one ultraviolet (UV) emitter capable of emitting light in the germicidal spectrum onto fluid contact surfaces of the lower reservoir to thereby disinfect a volume of the liquid in the lower reservoir.

13. The liquid purifying apparatus of claim 12, wherein the filter housing has a body which extends at least partway into the upper and/or lower reservoir.

14. The liquid purifying apparatus of claim 12, wherein the UV emitter is a UV mercury lamp and does not extend into the lower reservoir.

15. The liquid purifying apparatus of claim 12, wherein the ultraviolet (UV) emitter is adapted to emit UV light in the germicidal spectrum onto fluid contact surfaces of the filter assembly.

16. The liquid purifying apparatus of claim 13, wherein the body comprises a plurality of apertures.

17. The liquid purifying apparatus of claim 12, wherein the UV emitter does not extend into the lower reservoir.

18. The liquid purifying apparatus of claim 17, wherein the UV emitter comprises one or more UV LEDs, line-shaped UV lamps, U-shaped UV lamps, circular UV lamps or semi-circular UV lamps.

19. The liquid purifying apparatus of claim 12, wherein the filter housing is coupled to the filter assembly by a threaded or magnetic coupling.

20. The liquid purifying apparatus of claim 12, wherein the disinfection assembly is coupled to the third opening at the bottom of the container by a threaded coupling.
